(19) United States
(12) Patent Application Publication
(10) Pub. No.: US 2003/0013495 A1
(43) Pub. Date: Jan. 16, 2003

(54) Adaptive audible alert volume control

(76) Inventor: Jeffrey A. Oleksy, San Marcos, CA (US)

Correspondence Address: QUALCOMM Incorporated, Attn: Patent Department, 5775 Morehouse Drive, San Diego, CA, 92121-1714, US

(21) Appl. No.: 09/905,265

(22) Filed: Jul. 13, 2001

(51) Int. Cl. H04M 1/00

(52) U.S. Cl. 455/567; 455/458

(57) ABSTRACT

The adaptive audible alert volume control process automatically adjusts the volume of a telephone's alert tone by sampling the ambient sound level at the time a call is received. When the telephone receives a call indication from the system, it samples the ambient sound level through the telephone's microphone. The sampled ambient sound level is then compared to at least one threshold to determine a volume at which to set the alert tone.

### BACKGROUND OF THE INVENTION

1. Field of the Invention

The present invention relates generally to volume control in an electronic device. Particularly, the present invention relates to automatic volume control of an audible alert tone in an electronic device.

2. Description of the Related Art

The popularity of the cellular telephone and other mobile communication devices has created both a favorable and an unpleasant effect for the average consumer. On the one hand, the convenience of being able to call anywhere in the world while driving down the interstate highway can greatly increase the efficiency and productivity of most people. On the other hand, the ubiquitous nature of the cellular telephone and their alert tones can be annoying and disruptive.

For example, a loud telephone alert tone going off in a library would tend to bother anyone within a hundred feet of the telephone. Courtrooms and most meetings ban the use of the cellular telephone due to the disruptive nature of their alert tones.

Typically, a cellular telephone has a control function to reduce or mute the alert tone. In fact, a number of modern cellular telephones have a vibration mode that alerts the user to a call while not bothering others around the user. However, if the user has come from a noisy environment, such as the car, to a quiet environment, such as a meeting, the user must remember to either turn down the alert tone volume or turn off the telephone completely. There is a resulting need for an automatic alert tone volume adjustment process in a communication device.

### SUMMARY OF THE INVENTION

The present invention encompasses a process for automatically modifying an alert tone volume of a mobile communications device. In the preferred embodiment, the mobile communications device is a cellular telephone that has a microphone, an alert tone generator, and a vibrating alert generator.

The process of the present invention is initiated when an incoming call indication is received. The communications device's controller samples the ambient sound level. This sampled signal is then compared to a threshold to determine whether to activate the vibrator alert generator or to activate the alert tone generator and adjust its output level.

In one embodiment, the ambient sound level is compared to a plurality of sound level thresholds. If the ambient sound level is less than a predetermined minimum level (i.e., the surrounding area is quiet), the vibrator alert generator is activated in order to alert the user to an incoming call without disturbing others in the quiet surroundings.

If the ambient sound level is greater than the minimum threshold but less than a mid-level threshold, the alert tone generator is activated and set at a low volume. If the ambient sound level is between the mid-level threshold and a high threshold, the alert tone generator is set to a mid-level volume. Finally, if the ambient sound level is greater than the high threshold, the alert tone generator is set to a high volume.

### BRIEF DESCRIPTION OF THE DRAWINGS

FIG. 1 shows block diagram of a communication device in accordance with the present invention.

FIG. 2 shows a flowchart of the adaptive audible alert tone volume adjust process of the present invention.

### DETAILED DESCRIPTION OF THE PREFERRED EMBODIMENT

The adaptive audible alert volume control process of the present invention provides a user of a cellular telephone with the ability to use the telephone in various areas without worrying about manually changing the alert volume or turning the telephone off. This is accomplished by adjusting the alert tone's volume in response to the ambient noise levels.

The subsequent discussion of the present invention refers to a cellular telephone. It is understood, however, that the adaptive process works with any form of communication device that has an alert tone generator and a microphone to sample the ambient noise levels. These communication devices include radios such as MOTOROLA'S TALKABOUT radios and cordless telephones for home use.

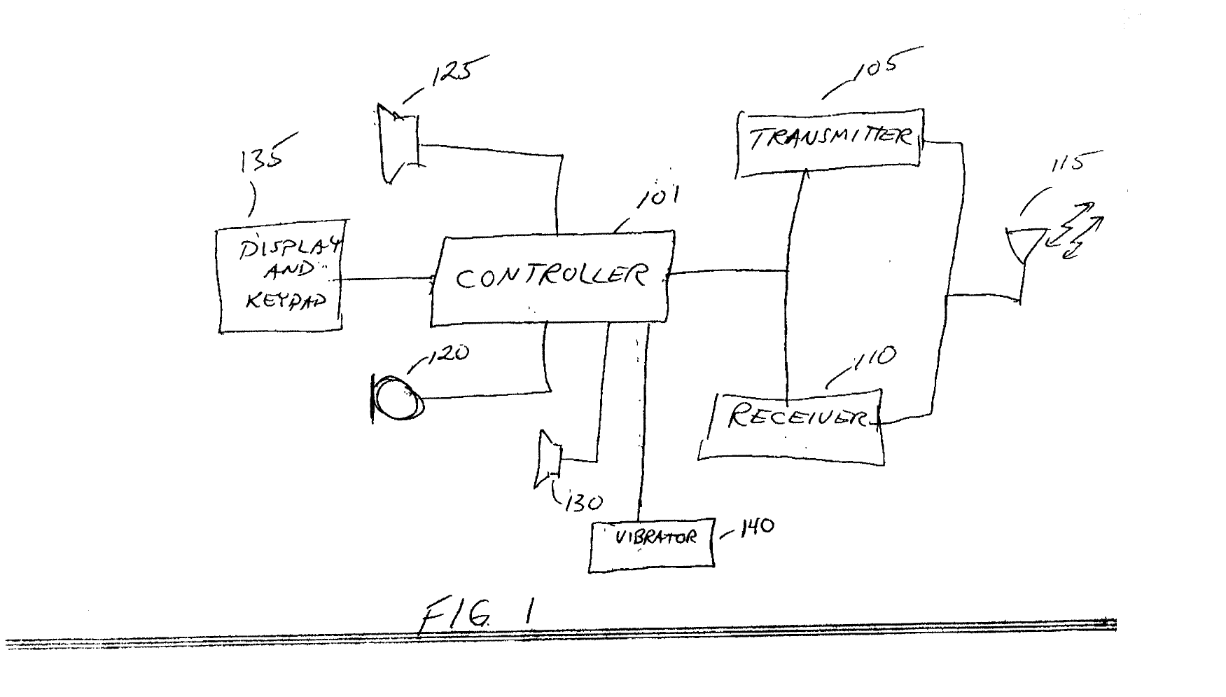

FIG. 1 illustrates a block diagram of a cellular telephone that incorporates the adaptive audible alert volume control process. The telephone is comprised of an antenna (115) that transmits signals to and receives signals from a base station. A transmitter (105) is responsible for transmitting any telephone signals from the telephone. For example, if the telephone user were to talk into the telephone's microphone (120), the speech signal would be processed by the controller (101) and transmitter (105) to be compliant with the appropriate air interface technology (e.g., code division multiple access) before being transmitted by the transmitter (105).

A receiver (110) is coupled to the antenna (115) to process any received telephone signals. For example, an incoming call indication signal might be received to indicate that another party is trying to reach the telephone's user.

The controller (101) is a processor or a microcontroller that controls the operation of the telephone. The controller (101) is responsible for performing the processes of the present invention.

The microphone (120) receives the speech signal and converts it into an electrical representation for processing by the controller (101) and transmitter (105). The adaptive audible alert volume control process uses the microphone (120) to sample the ambient sound levels of the telephone's environment.

In an alternate embodiment, the telephone is comprised of a second microphone that is separate from the normal telephone microphone (120). This second microphone is dedicated to the sampling of the ambient noise levels.

A speaker (125) radiates any voice signals received by the telephone and processed by the receiver (110) and controller (101). For example, the speech signal of the calling party is received and processed by the receiver (110) and controller (101) before being sent to the speaker (125) for conversion into an aural signal.

A display and keypad (135) are used to input and display data. The telephone user can determine the operating status of the telephone by display (135) indications. The user can also enter telephone numbers and other data with the keypad in conjunction with the display (135).

An alert transducer (130) generates the tones required to alert the telephone user to an incoming call. The alert transducer (130) receives signals of different frequencies and power levels from the controller (101). The transducer (130) then vibrates at those frequencies and levels under control of the process of the present invention.

A vibrating alert generator (140) is another means by which the telephone's controller (101) can alert the user to an incoming telephone call. The vibrating alert generator (140) is coupled to the telephone's housing and causes it to vibrate when so instructed by the controller (101) under command of the process of the present invention.

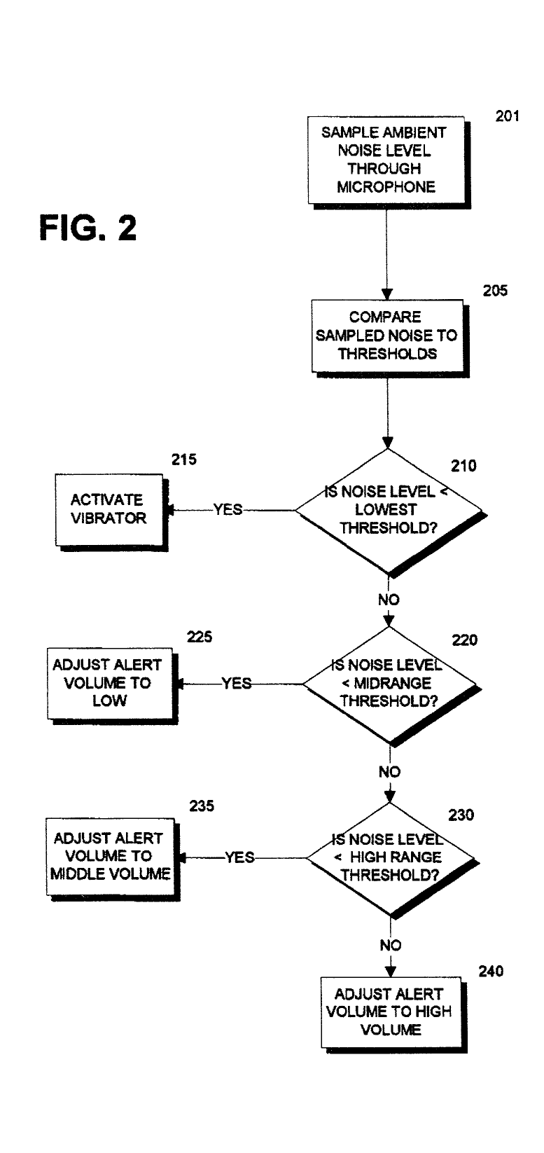

FIG. 2 illustrates a flowchart of the adaptive alert volume control process of the present invention. The process is initiated when an incoming call indication signal is received. The telephone's controller samples the ambient noise levels through the telephone's microphone (step 201).

The sampling process, in the preferred embodiment, is accomplished by the controller monitoring and digitizing the incoming ambient noise from the microphone. This digitizing process is well know in the art and is not discussed further. In an alternate embodiment, the sampling of the ambient noise through the microphone is accomplished in an analog fashion whereby the ambient signal strength is determined without digitizing the ambient noise signal.

The sampled ambient noise level is then compared to at least one threshold (step 205). In the preferred embodiment, the sampled ambient noise level is compared to multiple thresholds in order to determine at what volume level to set the audible alert. This permits the process of the present invention to take advantage of the multiple alert volume levels available on a cellular telephone.

The process first compares the sampled ambient noise level to the lowest threshold (step 210). If the noise level is less than this level, the telephone is in very quiet surroundings and any audible alert tone would be too much. Therefore, the telephone's vibrating alert generator is activated to indicate the incoming call.

If the noise level is greater than the lowest noise threshold but less than a predetermined mid-range threshold (step 220), the audible alert transducer is activated at its lowest volume setting (step 225). If the noise level is greater than the mid-range threshold but less than a maximum noise level threshold (step 230), the alert transducer is activated at a mid-level volume (step 235) to indicate the incoming call.

If the noise level is greater than the maximum noise level threshold (step 230), the alert transducer is activated at it highest volume setting (step 240) to indicate the incoming call. In one embodiment, the audible alert transducer as well as the vibrating alert generator are activated at this level since the user may not hear the audible alert transducer in such a noisy environment. In this case, the vibrating telephone may catch the user's attention before the audible alert transducer.

In one embodiment, the different thresholds of the present invention are determined by experimentation and then programmed into the telephone's firmware. For example, experimentation may show that 20 dB should be the lowest threshold, 60 dB should be the mid-range threshold, and 80 dB should be the high range threshold. These values would then be programmed into the telephone such that the process of the present invention automatically checks against these levels. These thresholds are for illustration purposes only. The present invention encompasses an unlimited range of threshold quantities as well as various threshold levels.

In an alternate embodiment, the user is able to program their own thresholds into the telephone. The user may call up a menu item that instructs the controller to sample the ambient noise levels at the time that the user pushes a button or switch. This sampled level is then programmed into the telephone as the level that is chosen by the user. This process is then continued until all of the available thresholds are chosen.

In summary, the adaptive audible alert volume control process of the present invention provides a cellular telephone user with the convenience of using the telephone without worrying that the alert tone will bother others at an inappropriate time. By comparing a sampled ambient noise level to a threshold or multiple thresholds, the volume of the alert tone can be adjusted in a dynamic manner.

1. A method for adaptively modifying an alert tone volume of a mobile communications device, the method comprising the steps of:
sampling an ambient sound level;
comparing the ambient sound level to a predetermined sound threshold;
if the ambient sound level is less than the predetermined sound threshold, reducing the volume by a predetermined amount; and
if the ambient sound level is greater than the predetermined sound threshold, increasing the volume by a predetermined amount.

2. The method of claim 1 wherein the mobile communications device is a cellular telephone.

3. The method of claim 1 wherein the mobile communications device is a radio.

4. The method of claim 1 and further including the step of generating the predetermined sound threshold by sampling an ambient sound level in response to an activation of a switch on the mobile communications device.

5. A method for adaptively modifying an alert tone volume of a mobile communications device, the method comprising the steps of:
sampling an ambient sound level;
comparing the ambient sound level to at least one of a plurality of predetermined thresholds;
if the ambient sound level is less than a lowest predetermined threshold of the plurality of predetermined thresholds, adjusting the alert tone volume to a lowest level;
if the ambient sound level is greater than the lowest predetermined threshold and less than a second predetermined threshold of the plurality of predetermined thresholds, adjusting the alert tone volume to a midrange level; and
if the ambient sound level is greater than the second predetermined threshold, adjusting the alert tone volume to a high range level.

6. The method of claim 5 wherein the step of sampling the ambient sound level comprises the step of converting the ambient sound level to a digital signal.

7. The method of claim 5 wherein the step of sampling the ambient sound level comprises the step of determining an analog signal level of the ambient sound level.

8. A method for adaptively modifying an alert tone in a cellular telephone comprising a microphone and an alert vibrator, the method comprising the steps of:
receiving an incoming call notification signal;
sampling an ambient sound level through the microphone;
comparing the ambient sound level to at least one of a plurality of predetermined thresholds;
if the ambient sound level is less than a lowest predetermined threshold of the plurality of predetermined thresholds, activating the alert vibrator;
if the ambient sound level is greater than the lowest predetermined threshold and less than a second predetermined threshold of the plurality of predetermined thresholds, adjusting the alert tone volume to a low level;
if the ambient sound level is greater than the second predetermined threshold and less than a third predetermined threshold of the plurality of predetermined thresholds, adjusting the alert tone volume to a mid-range level; and
if the ambient sound level is greater than the third predetermined threshold, adjusting the alert tone volume to a high level.

9. The method of claim 8 and further including the step of increasing the alert tone volume after a predetermined quantity of alert tones.

10. In a mobile communications device comprising an alert vibrator, an alert tone generator, and a microphone, an alert tone control apparatus comprising:
means for sampling an ambient sound level through the microphone;
means for comparing the ambient sound level to at least one of a plurality of predetermined thresholds;
means for activating the alert vibrator in response to the difference between the ambient sound level and the at least one of the plurality of predetermined thresholds; and
means for adjusting the alert tone generator in response to the difference between the ambient sound level and the at least one of the plurality of predetermined thresholds.

11. The apparatus of claim 10 and further including an analog to digital converter that converts an analog ambient sound signal to a digital ambient sound signal.

12. In a code division multiple access cellular telephone comprising an alert vibrator, an alert tone generator, and a microphone, an alert tone control apparatus comprising:
means for sampling an ambient sound level through the microphone;
means for comparing the ambient sound level to at least one of a plurality of predetermined thresholds;
means for activating the alert vibrator in response to the difference between the ambient sound level and the at least one of the plurality of predetermined thresholds; and
means for adjusting the alert tone generator in response to the difference between the ambient sound level and the at least one of the plurality of predetermined thresholds.

13. The apparatus of claim 12 and further including a receiver that receives an incoming call indication signal.

14. The apparatus of claim 13 wherein the means for sampling operates in response to the incoming call indication signal.

15. The apparatus of claim 13 and further including an analog to digital converter that converts the ambient sound level to a digital signal.

16. A method for adaptively modifying an alert tone volume of a mobile communications device, the method comprising the steps of:
generating a sound threshold by sampling a first ambient sound level in response to a switch activation;
receiving a call indication;
sampling a second ambient sound level;
comparing the second ambient sound level to the sound threshold;
if the second ambient sound level is less than the sound threshold, reducing the volume by a predetermined amount; and
if the second ambient sound level is greater than the sound threshold, increasing the volume by a predetermined amount.
